(19) United States
(12) Patent Application Publication
(10) Pub. No.: US 2022/0283644 A1
(43) Pub. Date: Sep. 8, 2022

(54) DEVICE AND METHOD FOR GESTURE BASED APPLICATION CONTROL

(71) Applicant: Honda Motor Co., Ltd., Tokyo (JP)

(72) Inventors: Christopher John Tarchala, Torrance, CA (US); Hanna Gee, Torrance, CA (US); Jonathan Palmer Neill, Grand Rapids, MI (US)

(21) Appl. No.: 17/192,123

(22) Filed: Mar. 4, 2021

(51) Int. Cl. G06F 3/01; G06F 3/0346; G06F 3/14; G06F 3/0488

(52) U.S. Cl. CPC G06F 3/017; G06F 3/0346; G06F 3/14; G06F 3/04883

(57) ABSTRACT

An electronic device is provided. The electronic device stores gesture mapping information indicating an association between a plurality of gestures and a plurality of functions associated with a plurality of applications of the electronic device. The electronic device receives first information about a first gesture, from a first user interface of the electronic device. The electronic device further determines a first set of functions, related to the plurality of applications, based on the stored gesture mapping information and the received first information. The electronic device further receives second information about a second gesture, from the first user interface. The second information about the second gesture received within a predefined time from the receipt of the first information and associated with a first function of the first set of functions. The electronic device further controls an execution of the first function associated with the second gesture.

### BACKGROUND

Electronic devices (such as mobile phones) may generally include one or more applications (such as a gaming application, a banking application, etc.) to perform one or more functions (such as games, banking activities, etc.). The one or more functions may correspond to or may be accessed by one or more user interface elements (such as icons) associated with the electronic device. In some cases, the electronic device may display such user interface elements, so that, a user may manually select a function of an application of interest from the displayed user interface elements. At times, it may be difficult for the user to identify a location of the displayed user interface elements that corresponds to the function or may be difficult to quickly access the function or related application. Further, it may be time consuming for the user to manually search for the displayed user interface elements that corresponds to the function.

### SUMMARY

An exemplary aspect of the disclosure provides an electronic device. The electronic device may include a memory which may store gesture mapping information that may indicate an association between a plurality of gestures and a plurality of functions. The plurality of functions may be associated with a plurality of applications configured in the electronic device. The electronic device may further include a processor that may be communicably coupled with the memory. The processor may receive first information about a first gesture of the plurality of gestures, from a first user interface of the electronic device. The processor may further determine a first set of functions that may be related to a first set of applications of the plurality of applications based on the stored gesture mapping information and the received first information. The first set of functions may be associated with the first gesture. The processor may further receive second information about a second gesture of the plurality of gestures, from the first user interface. The second information about the second gesture may be received within a predefined time from the receipt of the first information and may be associated with a first function of the first set of functions. The processor may further control an execution of the first function associated with the second gesture.

Another exemplary aspect of the disclosure provides a method for a gesture-based application control executed by an electronic device. The method may include storing gesture mapping information that may indicate an association between a plurality of gestures and a plurality of functions. The plurality of functions may be associated with a plurality of applications that may be configured in the electronic device. The method may further include receiving first information about a first gesture of the plurality of gestures, from a first user interface of the electronic device. The method may further include determining a first set of functions, which may be related to a first set of applications of the plurality of applications, based on the stored gesture mapping information and the received first information. The first set of functions may be associated with the first gesture. The method may further include receiving second information about a second gesture of the plurality of gestures from the first user interface. The second information about the second gesture may be received within a predefined time from the receipt of the first information and may be associated with a first function of the first set of functions. The method may further include controlling an execution of the first function associated with the second gesture.

Another exemplary aspect of the disclosure provides a non-transitory computer-readable medium. The non-transitory computer-readable medium may store thereon, computer-executable instructions which, when executed by an electronic device, cause the electronic device to execute operations. The operations may include storing gesture mapping information that may indicate an association between a plurality of gestures and a plurality of functions. The plurality of functions may be associated with a plurality of applications that may be configured in the electronic device. The operations may further include receiving first information about a first gesture of the plurality of gestures, from a first user interface of the electronic device. The operations may further include determining a first set of functions, which may be related to a first set of applications of the plurality of applications, based on the stored gesture mapping information and the received first information. The first set of functions may be associated with the first gesture. The operations may further include receiving second information about a second gesture of the plurality of gestures, from the first user interface. The second information about the second gesture may be received within a predefined time from the receipt of the first information and may be associated with a first function of the first set of functions. The operations may further include controlling an execution of the first function associated with the second gesture.

### BRIEF DESCRIPTION OF THE DRAWINGS

FIG. 1 is a block diagram that illustrates an exemplary network environment for a gesture-based application control in accordance with an embodiment of the disclosure.

FIG. 2 is a block diagram that illustrates an electronic device for a gesture-based application control in accordance with an embodiment of the disclosure.

FIGS. 3A-3C are diagrams that collectively illustrate a first exemplary scenario for a gesture-based application control in the electronic device of FIG. 1 in accordance with an embodiment of the disclosure.

FIGS. 4A-4C are diagrams that collectively illustrate exemplary gestures for a gesture-based application control in the electronic device of FIG. 1 in accordance with an embodiment of the disclosure.

FIGS. 5A-5D are diagrams that collectively illustrate a second exemplary scenario for a gesture-based application control in the electronic device of FIG. 1 in accordance with an embodiment of the disclosure.

FIGS. 6A-6C are diagrams that collectively illustrate a third exemplary scenario for a gesture-based application control in the electronic device of FIG. 1 in accordance with an embodiment of the disclosure.

FIGS. 7A-7D are diagrams that collectively illustrate a fourth exemplary scenario for a gesture-based application control in the electronic device of FIG. 1 in accordance with an embodiment of the disclosure.

FIGS. 8A-8D are diagrams that collectively illustrate a fifth exemplary scenario for a gesture-based application control in the electronic device of FIG. 1 in accordance with an embodiment of the disclosure.

FIG. 9 is a flowchart that illustrates exemplary operations for a gesture-based application control in the electronic device of FIG. 1 in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed electronic device (such as a mobile phone or a vehicle infotainment system). Exemplary aspects of the disclosure may provide the electronic device that may be configured to perform a gesture-based application control. The gesture-based application control may relate to a control of an application (such as, but not limited to, a location tracking application, or other applications) configured or installed in the electronic device, based on a gesture (such as a touch gesture) and gesture mapping information. The gesture mapping information may indicate an association between a plurality of gestures and a plurality of functions that may be associated with a plurality of applications of the electronic device.

For example, if a user or a user device (such as a touch pen or stylus) selects or accesses a first set of functions related to a first set of applications of interest, using a first gesture of the plurality of gestures from a first user interface (such as a touch screen) of the electronic device, the electronic device may receive first information about the first gesture. The first gesture may be the touch gesture to create a pattern of a character, a symbol or a shape. Based on the received first information and the gesture mapping information, the electronic device may determine the first set of functions related to the first set of applications of interest and control the execution of the first set of functions based on the determination. Hence, such gesture-based application control may improve time-efficiency to access the required set of functions, as compared to traditional methods of application control (such as, manually identifying location of an icon associated with an application configured in the electronic device, hovering over the icon, and selecting the icon to access the application). Details of such gesture-based application control of the electronic device are further described, for example, in 3A-3C, 4A-4C, 5A-5D, 6A-6C, 7A-7D, and 8A-8D.

In an embodiment, the electronic device may also receive second information about a second gesture (such as a touch gesture or a motion gesture) of the plurality of gestures from the first user interface (such as the touch screen or a motion interface). The second information may be associated with a first function of the first set of functions of the first set of applications of interest. In a scenario, the first set of functions may be associated with a single application of the plurality of applications. In such scenario, the first function determined based on the second gesture and the first set of functions determined based on the first gesture, may be a part of the single application. Hence, the electronic device may also facilitate a secondary gesture-based application control to directly access the first function associated with the application of interest and may further improve time efficiency to access the first function, as compared to the traditional methods of the application control. Details of such secondary gesture-based application control of the electronic device are further described, for example, in 3A-3C, 4A-4C, 5A-5D, 6A-6C, 7A-7D, and 8A-8D.

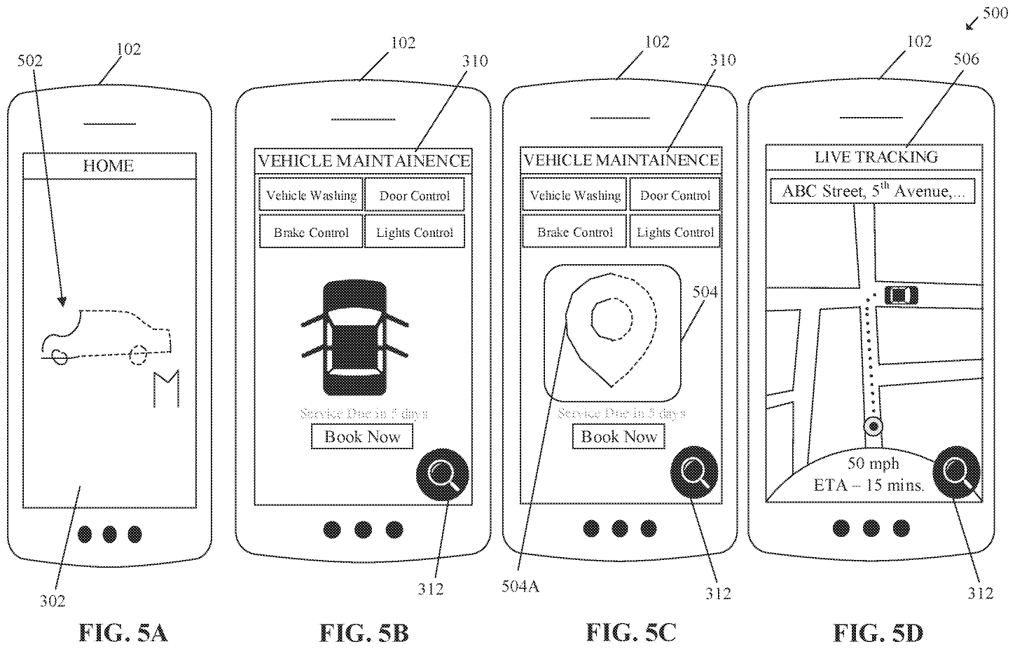

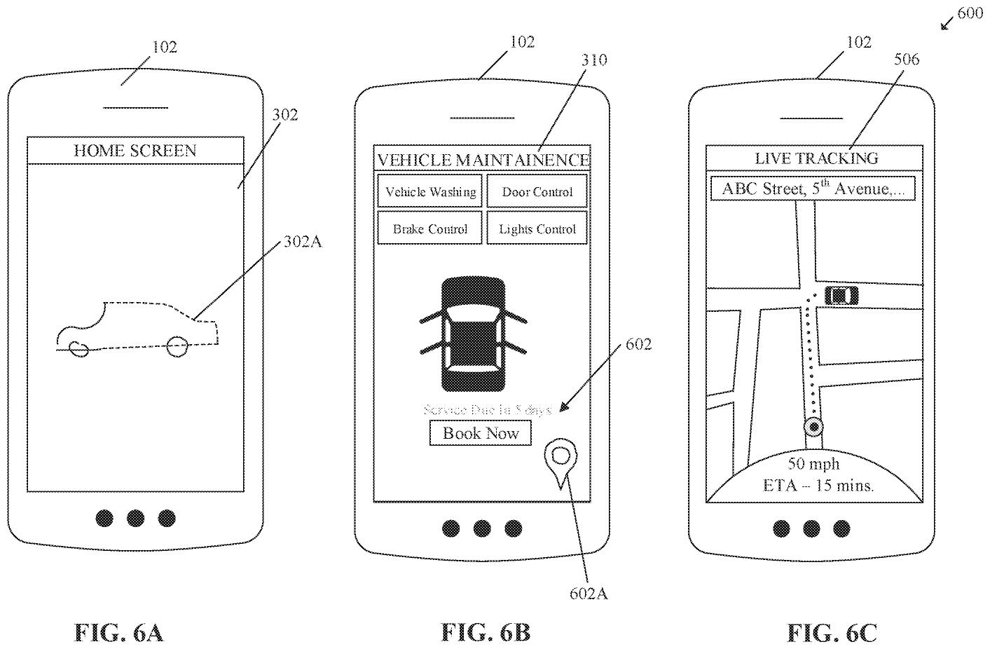

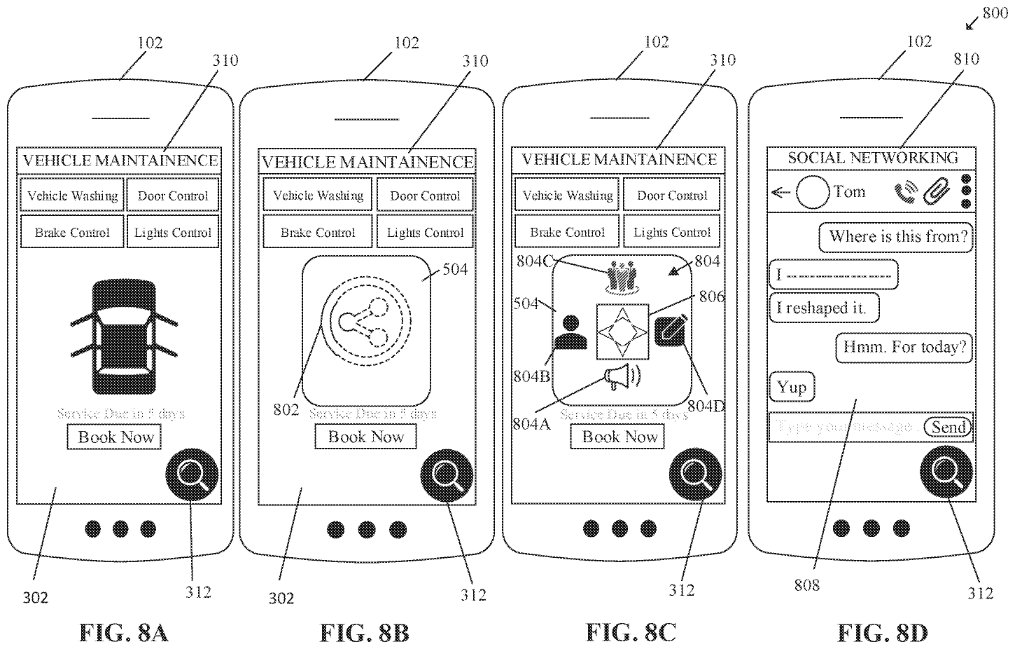

In another scenario, the first set of functions may be associated with multiple applications of the plurality of applications. In one example, at least one function associated with the first gesture, may relate to a first application. Further, the first function associated with the second gesture may relate to a second application different from the first application. In such scenario, as the first function is not related to the first application, the electronic device may be configured to search outside the first application and identify or access the corresponding first function in the second application, and thereby reduce time that may have taken to switch between different applications. Thus, the electronic device may also be configured to perform a global search on the stored gesture mapping information based on the received second information about the second gesture in addition to the received first information about the first gesture. Details of such secondary gesture-based application controls to swiftly switch between applications of the electronic device are further described, for example, in FIGS. 5A-5D, FIGS. 6A-6C, and in FIGS. 8A-8D.

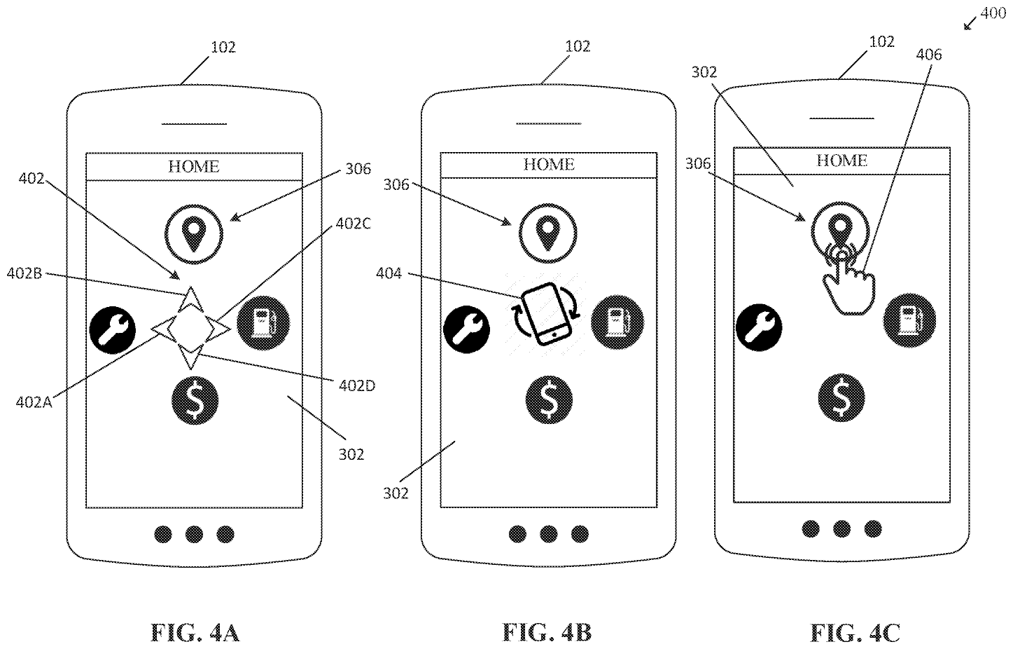

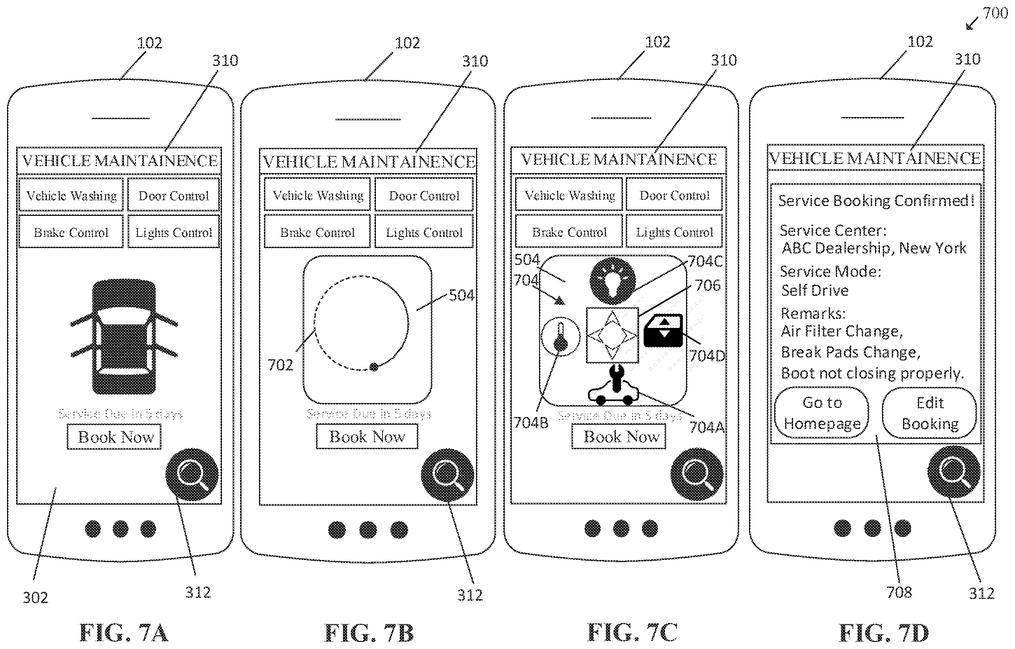

In yet another scenario, the second information about the second gesture may be received based on a trigger of a user interface element (such as a button) that may be associated with the first user interface (such as the touch screen). For example, the second information about the second gesture may be received from a portion (such as a pop-window) that may overlay on the first user interface based on the trigger of the user interface element. Based on user requirements, the overlaid portion may have an opaque or a transparent background when the portion overlays on the first user interface. Therefore, the overlaid portion may enhance user experience during the receipt of the second information about the second gesture. Details of such secondary gesture-based application control of the electronic device are further described, for example, in FIGS. 5B-5D and 7A-7C. The second information about the second gesture may also be received based on the motion gesture. Details of such motion gesture-based application control of the electronic device are further described, for example, in FIGS. 4A-4C.

Reference will now be made in detail to specific aspects or features, examples of which are illustrated in the accompanying drawings. Wherever possible, corresponding or similar reference numbers will be used throughout the drawings to refer to the same or corresponding parts.

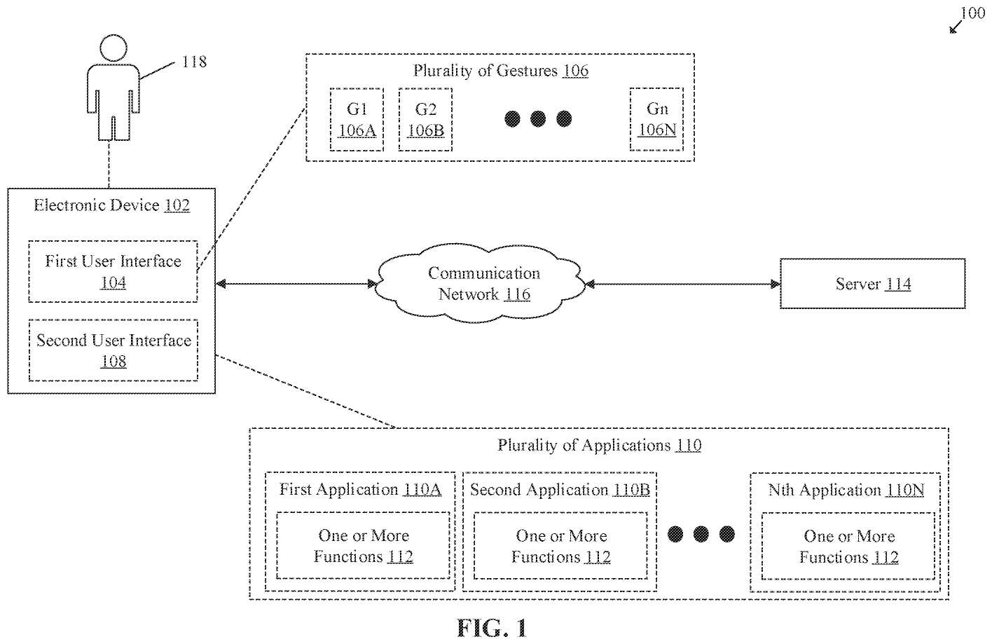

FIG. 1 is a block diagram that illustrates an exemplary network environment for a gesture-based application control in accordance with an embodiment of the disclosure. There is shown a network environment 100 that may include an electronic device 102. The electronic device 102 may include a first user interface 104 that may be configured to receive information about a plurality of gestures 106. The electronic device 102 may further include a second user interface 108 that may be configured to display information of one or more user interface elements related to a plurality of applications 110 based on the received information about the plurality of gestures 106. The plurality of applications 110 may include one or more functions 112 that may be associated with the plurality of gestures 106. The network environment 100 may further include a server 114. The electronic device 102 may be communicably coupled to the server 114, via a communication network 116, to receive gesture mapping information that may indicate an association between the plurality of gestures 106 and the one or more functions 112 of the plurality of functions. In some embodiments, the gesture mapping information may be prestored in the electronic device 102. Modifications, additions, or omissions may be made to FIG. 1 without departing from the scope of the present disclosure.

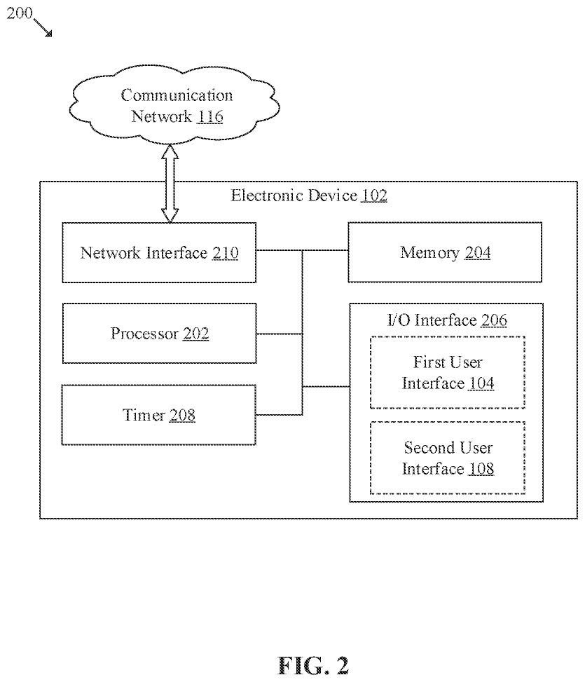

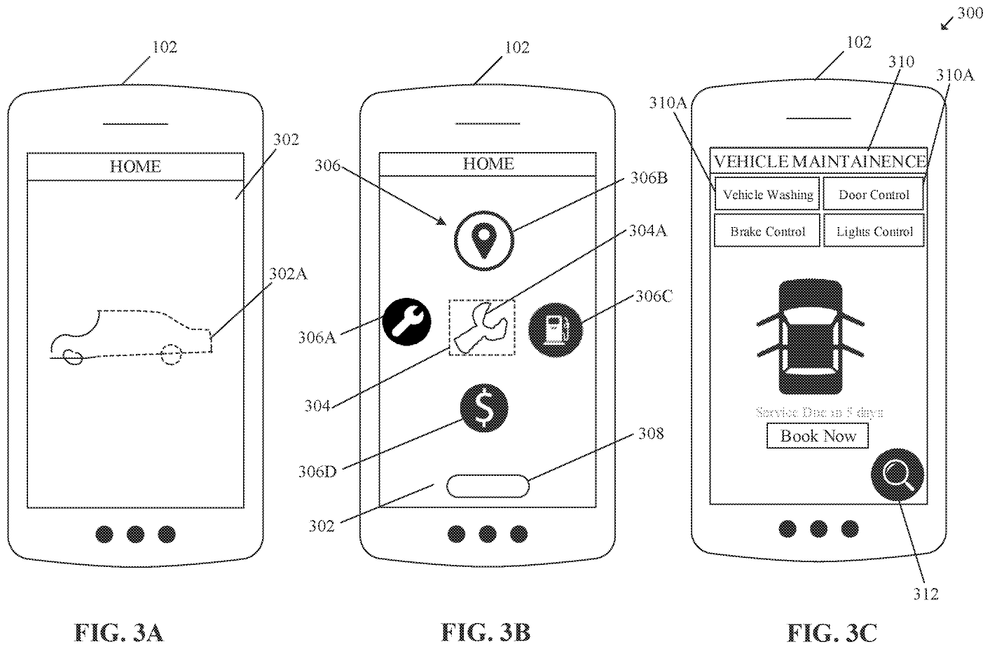

The network environment 100 may be an exemplary representation of components that may be associated with the electronic device 102. In an embodiment, the network environment 100 may include more or fewer elements than those illustrated and described in the present disclosure. For example, the network environment 100 may not include the server 114, without deviation from the scope of the disclosure. In such scenario, the gesture mapping information may be directly stored (as described in FIG. 2) in the electronic device 102. In another example, the electronic device 102 may include the first user interface 104 without the second user interface 108. In such scenario, the first user interface 104 may be configured to receive the information about the plurality of gestures 106 and further display the one or more user interface elements (or other information) related to one or more functions 112 associated with the plurality of applications 110. Details of such display of the one or more user interface elements (or other information) related to the one or more functions 112 are further described, for example, in FIGS. 3A-3C.

The electronic device 102 may include suitable logic, circuitry, and interfaces that may be configured to receive information about at least one gesture from the plurality of gestures 106 from the first user interface 104 of the electronic device 102. The electronic device 102 may further determine at least one function of the one or more functions 112 associated with the plurality of applications 110, based on the pre-stored gesture mapping information and the received information. The electronic device 102 may be further configured to perform a control of the function of the one or more functions 112, based on the determination. The electronic device 102 may be further configured to display the one or more user interface elements (or other information) related to the one or more functions 112, based on the controlled at least one function of the one or more functions 112. Examples of the electronic device 102 may include, but are not limited to, a computing device, a mainframe machine, a server, a computer workstation, and/or a consumer electronic (CE) device.

In an embodiment, the electronic device 102 may be implemented as a mobile device. In such implementation, the electronic device 102 may include both the first user interface 104 and the second user interface 108. The mobile device may include suitable logic, circuitry, interfaces and/or code that may be configured to present at least a user interface to receive the information about at least one gesture of the plurality of gestures 106 and control at least one function of the plurality of applications 110, based on the received information about at least one gesture. In one embodiment, the mobile device may include entire functionality of the server 114, at least partially or in its entirety, without a deviation from the scope of the present disclosure. Examples of the mobile device may include, but are not limited to, a computing device, a smartphone, a cellular phone, a mobile phone, a gaming device, a camera device, and other portable devices.

In another embodiment, the electronic device 102 may be implemented as an in-vehicle infotainment system that may be integrated with a vehicle. The in-vehicle infotainment system may include suitable logic, circuitry, and/or interfaces that may be configured to present at least a user interface to receive the information about at least one gesture of the plurality of gestures 106 and control at least one function of the plurality of applications 110, based on the received information about at least one gesture. In one embodiment, the in-vehicle infotainment system may include entire functionality of the server 114, at least partially or in its entirety, without a deviation from the scope of the present disclosure. Examples of the in-vehicle infotainment system may include, but not limited to, an entertainment system, a navigation system, a vehicle user interface system, an Internet-enabled communication system, an in-car entertainment (ICE) system, an automotive Head-up Display (HUD), an automotive dashboard, a human-machine interface (HMI), and other entertainment systems. In an embodiment, the in-vehicle infotainment system may receive the information about at least one gesture from the plurality of gestures, from the first user interface 104.

The first user interface 104 may include suitable logic, circuitry, and interfaces that may be configured to receive user inputs (for example a touch-based gesture). The first user interface 104 may be a touch screen, which may be configured to receive the user inputs related to the plurality of gestures 106. For example, the first user interface 104 (such as the touch screen or a touch pad) may be coupled with the electronic device 102 (such as the mobile phone or the in-vehicle infotainment system) to receive the user inputs related to the plurality of gestures 106. In one embodiment, the first user interface 104 may include entire functionality of the second user interface 108 (i.e. display screen), at least partially or in its entirety, without a deviation from the scope of the present disclosure. Examples of the first user interface 104 may include, but not limited to, a resistive touchscreen, a capacitive touchscreen, a conductive touchscreen, a tactile touchscreen, a wireless touchscreen (such as an external touchpad), and the like. In an embodiment, the electronic device 102 may control the first user interface 104 to receive first information about a first gesture 106A of the plurality of gestures 106, from the first user interface 104. In additional embodiment, the electronic device 102 may control the first user interface 104 to receive second information about a second gesture 1066 of the plurality of gestures 106, from the first user interface 104.

The plurality of gestures 106 may correspond to the user inputs provided on the first user interface 104 to control the one or more functions 112 associated with the plurality of applications 110. In some embodiments, the plurality of gestures 106 may be provided on one or more user interface elements (i.e. rendered on or controlled via the first user interface 104) to control or access the one or more functions 112 associated with the plurality of applications 110. In an embodiment, the plurality of gestures 106 may include the first gesture 106A, a second gesture 106B, and a Nth gesture 106N, as shown in FIG. 1. The number of gestures shown in FIG. 1 is presented merely as an example. The plurality of gestures 106 may include only one gesture or more than N gestures, without deviation from the scope of the disclosure. Examples of each of the plurality of gestures 106 may include a touch gesture, or a motion gesture (such as a tilt gesture, an orientation gesture, or a shake gesture) associated with the electronic device 102.

In another scenario, the plurality of gestures 106 may also relate to a body gesture. The body gesture may include, but not limited to, a facial gesture, or a hand gesture. In an embodiment, the electronic device 102 may include an image capturing device (not shown) that may be configured to capture a plurality of images of a user 118 over a specified time period. The captured plurality of images may be utilized to determine the body gesture associated with the user 118. The body gesture may indicate one or more motions or positions of the user 118 (such as a hand, an eye, a mouth, a head, a nose, or eyebrows associated with the user 118). Based on the body gesture, the electronic device 102 may be configured to determine at least one function associated with the plurality of applications 110 and display information of the one or more user interface elements related to the determined function.

The second user interface 108 may include suitable logic, circuitry, and interfaces that may be configured to display the information of the one or more user interface elements related to the one or more functions 112 associated with the plurality of applications 110. For example, the second user interface 108 (such as a display screen) may be coupled with the electronic device 102 (such as the mobile device or the in-vehicle infotainment system) to display the information of the one or more user interface elements related to the one or more functions 112, based on the received user inputs from the first user interface 104. In one embodiment, the second user interface 108 may include entire functionality of the first user interface 104, at least partially or in its entirety, without a deviation from the scope of the present disclosure. Examples of the second user interface 108 may include, but not limited to, at least one of a Liquid Crystal Display (LCD) display, a Light Emitting Diode (LED) display, a plasma display, or an Organic LED (OLED) display technology, or other display devices. In accordance with an embodiment, the second user interface 108 may refer to a display screen of a head mounted device (HMD), a smart-glass device, a see-through display, a projection-based display, an electro-chromic display, or a transparent display screen. In some embodiments, the display functionality of the second user interface 108 may be integrated in the touch-based interface of the first user interface 104. In such embodiment, the first user interface 104 may be a touchscreen to receive the gesture-based user inputs and display the information of one or more user interface elements related to the one or more functions 112.

The plurality of applications 110 may be a program or a group of programs that may be stored or installed in the electronic device 102. Each application of the plurality of applications 110 may include one or more functions 112. In an embodiment, the electronic device 102 may be configured to perform one or more instructions associated with each function of the one or more functions 112. In one example, the plurality of applications 110 may be specific to a hardware capability or a software capability (such as operating system) of the mobile device or the in-vehicle infotainment system. The plurality of applications 110 may be executed on the operating system associated with the electronic device 102. In another embodiment, the plurality of applications 110 may be executed on any platform, which may be different from that of the electronic device 102. For example, one or more of the plurality of applications 110 may be executed or operational on the server 114 communicably coupled with the electronic device 102. The electronic device 102 may transmit information about the received user inputs (i.e. plurality of gestures 106) to the server 114 and further receive information about the one or more functions 112 of the related applications from the server 114. In an embodiment, the plurality of applications 110 may include a first application 110A, a second application 1106, and a Nth application 110N. The number of applications shown in FIG. 1 is presented merely as an example. The plurality of applications 110 may include only one application or more than N applications, without deviation from the scope of the disclosure.

Examples of the plurality of applications 110 may include, but is not limited to, a web browser, a vehicle related application, an email application, a chatting application, a social networking application, an audio-video communication application, a camera application, a financial application, a media player application, a file/document viewer application, content sharing application, a simulator application, a gaming application, a photo editor application, a location tracking application, a navigation application, an entertainment application, a health-related application, a sports-related application, an educational application, a text processing application, data processing application, an accounting application, a customer-care application, a transport application, a service provider-based application, and other applications that may be executed or configured on the electronic device 102.

The one or more functions 112 of each application of the plurality of applications 110, may relate to one or more instructions associated with each application of the plurality of applications 110. The one or more functions 112 may be a feature, a functionality, a program, a module, a component, or a part of each application. In an embodiment, the electronic device 102 may be configured to execute the one or more instructions associated with each function to perform the corresponding function. In one example, the one or more functions 112 may be specific to the mobile device as the electronic device 102. In other example, the one or more functions 112 may be specific to the in-vehicle infotainment system as the electronic device 102. In an embodiment, the one or more functions 112 may be specific to a hardware capability or specific to a software capability of the electronic device 102. In some embodiments, the one or more functions 112 may be executed on the server 114 and information about the one or more functions 112 may be rendered on the electronic device 102. For example, an application associated with the plurality of applications 110 is a vehicle maintenance application, then the one or more functions 112 associated with such vehicle maintenance application may include, but are not limited to, a vehicle service booking function, a notification feature, a payment feature, a vehicle telematics data access function, an audio-video communication feature, a vehicle door access feature, and other functions that may be related to the determined application from the plurality of applications 110. In another example, if the application is a social networking application, the one or more functions 112 may include, but are not limited to, a message transmission function, a search function, a tagging function, a document uploading function, a group formation function, a comment function, a like/dislike function, a security function, or other profile based function.

The server 114 may include suitable logic, circuitry, interfaces, and/or code that may be configured to collaborate with the electronic device 102, so that, the electronic device 102 may retrieve the gesture mapping information from the server 114, based on gesture-based user inputs received on the first user interface 104. For example, the electronic device 102 may determine a first set of functions, related to a first set of applications of the plurality of applications 110, based on the gesture mapping information that may be stored in the server 114 and based on the received first information about the first gesture 106A. In an embodiment, the first set of functions may be associated with the first gesture 106A. In some embodiments, the server 114 may execute one or more functions 112 related to the first gesture 106A and provide information about the executed one or more functions 112 to the electronic device 102. In some embodiments, the server 114 may store one or more applications of the plurality of applications 110 and execute one or more functions 112 related to the stored applications, based on a receipt of the first information about the first gesture 106A or the second information about the second gesture 106B from the electronic device 102. In an example, the server 114 may store one or more webpages related to different applications executed on the server 114 or executed directly on the electronic device 102. Based on the received first information or the second information about the first gesture 106A and the second gesture 106B, respectively, the server 114 may provide associated one or more webpages to the electronic device 102 to be presented to the user 118.

In an embodiment, the server 114 may be a cloud server, which may be utilized to execute various operations through web applications, cloud applications, HTTP requests, repository operations, file transfer, and the like. Examples of the server 114 may include, but are not limited to, an event server, a database server, a file server, a web server, a media server, a content server, an application server, a mainframe server, or a combination thereof. In one or more embodiments, the server 114 may be implemented as a plurality of distributed cloud-based resources. In a specific embodiment, the server 114 may be configured to communicate with at least one electronic device (such as, the electronic device 102), via the communication network 116.

The communication network 116 may include a communication medium through which the electronic device 102 and the server 114 may communicate with each other. The communication network 116 may be one of a wired connection or a wireless connection. Examples of the communication network 116 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 116 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In some embodiments, the communication network 116 may be an in-vehicle network. The in-vehicle network may include a medium through which various control units, components, and/or systems (for example the electronic device 102, the first user interface 104, the second user interface 108) of a vehicle (not shown) may communicate with each other. In accordance with an embodiment, in-vehicle communication of audio/video data may occur by use of Media Oriented Systems Transport (MOST) multimedia network protocol of the in-vehicle network or other suitable network protocols for vehicle communication. The MOST-based network may be a separate network from the controller area network (CAN). The MOST-based network may use a plastic optical fiber (POF) medium. In accordance with an embodiment, the MOST-based network, the CAN, and other in-vehicle networks may co-exist in the vehicle. The in-vehicle network may facilitate access control and/or communication between the control circuitry and other ECUs, such as ECM or a telematics control unit (TCU) of the vehicle. Various devices or components in the vehicle may connect to the in-vehicle network, in accordance with various wired and wireless communication protocols. Examples of the wired and wireless communication protocols for the in-vehicle network may include, but are not limited to, a vehicle area network (VAN), a CAN bus, Domestic Digital Bus (D2B), Time-Triggered Protocol (TTP), FlexRay, IEEE 1394, Carrier Sense Multiple Access With Collision Detection (CSMA/CD) based data communication protocol, Inter-Integrated Circuit (I²C), Inter Equipment Bus (IEBus), Society of Automotive Engineers (SAE) J1708, SAE J1939, International Organization for Standardization (ISO) 11992, ISO 11783, Media Oriented Systems Transport (MOST), MOST25, MOST50, MOST150, Plastic optical fiber (POF), Power-line communication (PLC), Serial Peripheral Interface (SPI) bus, and/or Local Interconnect Network (LIN).

In operation, the electronic device 102 may be operated to access or to control at least one function of an application of the plurality of applications 110. The electronic device 102 may be configured to receive the first information about the first gesture 106A (such as the touch gesture) that may be received on the first user interface 104 (such as a touch screen). The first gesture 106A may be received from a finger of the user 118 or from the user device (such as a touch stylus, not shown). The first gesture 106A may be a touch gesture or a touch pattern related to a character, a symbol, or a custom shape, drawn by the user 118 on the first user interface 104. Details of the first gesture 106A are provided, for example, in FIGS. 3A, 5A, 6A, 7B, and 8B.

Based on the received first information and the gesture mapping information (which may be stored in the electronic device 102 or the server 114), the electronic device 102 may determine the first set of functions (including one or more functions 112) that may be related to the first set of applications of the plurality of applications 110. The gesture mapping information may indicate an association or relationship between the plurality of gestures 106 (including the first gesture 106A) and a plurality of functions associated with the plurality of applications 110 (i.e. including the first set of applications) that may be configured/installed on the electronic device 102 or on the server 114. The electronic device 102 may further control the execution of the first set of functions based on the determination. For example, the execution may include, but is not limited to, display of icons or user interface elements associated with the first set of functions determined for the received first information about the first gesture 106A. The details of the first set of functions are provided, for example, at FIGS. 3B, 7C, and 8C. Such gesture-based application or function control may improve time-efficiency to access or control the functions of the applications, in comparison to traditional methods of application control or access.

In an embodiment, the electronic device 102 may also receive the second information about the second gesture 106B (such as a touch gesture or a motion gesture), from the first user interface 104 (such as the touch screen or a motion interface associated with the first user interface 104). In an embodiment, the second information about the second gesture 106B may be received, based on the receipt of the first information about the first gesture 106A. For example, the second information about the second gesture 106B may be received within a predefined time (for example in few milliseconds or seconds) from the receipt of the first information. The details about the second gesture 106B are provided, for example, in FIGS. 3B, 4A-4C, 5C, 6B, 7C, and 8C. In an embodiment, the second information may be associated with a first function of the first set of functions of the first set of applications of interest (i.e. determined based on the first gesture 106A). In a scenario, the first set of functions may be associated with the first application 110A of the plurality of applications 110. In such scenario, the first function determined based on (or associated with) the second gesture 106B and the first set of functions (i.e. determined based on the first gesture 106A) may be a part of the first application 110A. The electronic device 102 may be further configured to control an execution of the first function of the first application 110A that may be associated with the second gesture 106B. Details about the execution of the first function based on the received second gesture 106B are provided for example, in FIGS. 3C, 5D, 6C, 7D, and 8D. Hence, the electronic device 102 may also facilitate a secondary gesture-based application control (such as via the second gesture 106B in addition to the first gesture 106A) to directly access the first function associated with the first application 110A and may further improve time efficiency to access/execute the first function, in comparison to the traditional methods to access or control an application and related functions. Details of such secondary gesture-based application control of the electronic device 102 are further described, for example, in FIGS. 3A-3C, 4A-4C, 5A-5D, 6A-6C, 7A-7D, and 8A-8D.

In another scenario, the first set of functions may be associated with multiple and different applications (such as the first application 110A and the second application 1106) of the plurality of applications 110. In one example, at least one second function (i.e. different from the first function) of the first set of functions (i.e. associated with the first gesture 106A) may be related to the first application 110A of the first set of applications. Further, the first function associated with the second gesture 106B may relate to the second application 1106 of the first set of applications, where the second application 1106 is different from the first application 110A. In such scenario, as the first function (i.e. determined based on the second gesture 106B) is not related to the first application 110A, the electronic device 102 may be configured to search outside the first application 110A and identify the corresponding first function in the second application 1106, and thereby reduce time that may have taken to switch between applications (i.e. the first application 110A to the second application 1106) of the plurality of applications 110. Thus, the electronic device 102 may also perform a global search (i.e. in all applications configured in the electronic device 102) based on the stored gesture mapping information and based on the combination of the second information about the second gesture 106B and the received first information about the first gesture 106A. Details of such secondary gesture-based application control to swiftly switch between applications of the electronic device 102 are further described, for example, in FIGS. 5A-5D, FIGS. 6A-6C, and in FIGS. 8A-8D.

FIG. 2 is a block diagram that illustrates an electronic device for a gesture-based application control in accordance with an embodiment of the disclosure. FIG. 2 is explained in conjunction with elements from FIG. 1. There is shown a block diagram 200 of the electronic device 102. The electronic device 102 may include processor 202, a memory 204, a I/O interface 206, a timer 208, and a network interface 210. The first user interface 104 and the second user interface 108 may be integrated in the I/O interface 206 of the electronic device 102. In some embodiments, the first user interface 104 and the second user interface 108 may be communicably coupled to the network interface 210 of the electronic device 102, via the communication network 116.

The processor 202 may include suitable logic, circuitry, and/or interfaces that may be configured to execute program instructions associated with different operations to be executed by the electronic device 102. For example, some of the operations may include, but are not limited to, reception of the first information about the first gesture 106A of the plurality of gestures 106, from the first user interface 104 of the electronic device 102, determination of the first set of functions, related to the first set of applications (such as the first application 110A and the second application 1106) of the plurality of applications 110, reception of the second information about the second gesture 1066 of the plurality of gestures 106, from the first user interface 104, and a control of the execution of the first function (i.e. one of the first set of functions) associated with the second gesture 106B of the plurality of gestures 106. The execution of operations may be further described, for example, in FIGS. 3A-3C.

The processor 202 may include any suitable special-purpose or general-purpose computer, computing entity, or processing device including various computer hardware or software modules and may be configured to execute instructions stored on any applicable computer-readable storage media (for example the memory 204). The processor 202 may be implemented based on several processor technologies known in the art. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The processor 202 may include any number of processors configured to, individually or collectively, perform any number of operations of the electronic device 102, as described in the present disclosure. Examples of the processor 202 may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory 204 may include suitable logic, circuitry, interfaces, and/or code that may be configured to store the set of instructions executable by the processor 202. In an embodiment, the memory 204 may be configured to store the gesture mapping information that may indicate the association or relationship between the plurality of gestures 106 and the plurality of functions (such as including the one or more functions 112). The plurality of functions may be associated with the plurality of applications 110 configured or installed in the electronic device 102. In an embodiment, the processor 202 may retrieve information about the first set of functions associated with the first gesture 106A and retrieve information about the first function associated with the second gesture 1066, from the gesture mapping information stored in the memory 204. The memory 204 may also store the first information about the first gesture 106A, the second information about the second gesture 106B, information about one or more functions 112 associated with each of the plurality of applications 110, and information about one or more user interface elements related to the one or more functions 112. In an embodiment, the memory 204 may also store information associated with one or more control instructions to control the execution of the first function associated with the second gesture 106B. Examples of implementation of the memory 204 may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O interface 206 may include suitable logic, circuitry, interfaces, and/or code that may be configured to receive the user inputs and may render output in response to the received user inputs (such as the plurality of gestures 106) from the user 118 or from the user device (such as a touch stylus or pen). In an embodiment, the I/O interface 206 may be integrally coupled to the electronic device 102 to receive the user inputs from the first user interface 104 and control the first function associated with at least one application of the plurality of applications 110. In another embodiment, the I/O interface 206 may be communicably coupled to the electronic device 102 to receive the user inputs. In some embodiments, the I/O interface 206 may include the first user interface 104 and the second user interface 108. In another embodiment, the I/O interface 206 may include various input and output devices that may be configured to communicate with the processor 202. Examples of the such input and output devices may include, but are not limited to, a touch screen, a touch pad, a keyboard, a mouse, a joystick, a microphone, a display device, a speaker, and/or an image sensor.

The timer 208 may include suitable logic, circuitry, interfaces, and/or code that may be configured to set a predefined time period (for example in milliseconds or seconds) to receive the second information about the second gesture 1066 after the receipt of the first information about the first gesture 106A. In an embodiment, the electronic device 102 may be configured to receive the second information about the second gesture 106B within the predefined time period set by the timer 208, from the receipt of the first information. In an example, the timer 208 may include a digital counter or clock to countdown to the predetermined time period which may be set by the processor 202. Examples of the timer 208 may include, but not limited to, a software timer, a digital clock, or an internal clock associated with the electronic device 102. In an embodiment, the electronic device 102 may activate the timer 208 for the predetermined time period based on the reception of the first information about the first gesture 106A.

The network interface 210 may include suitable logic, circuitry, and interfaces that may be configured to facilitate communication between the processor 202 and the communication network 116. The network interface 210 may be implemented by use of various technologies to support wired or wireless communication of the electronic device 102 with the communication network 116. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 210 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

Although in FIG. 2, it is shown that the electronic device 102 includes the processor 202, the memory 204, the I/O interface 206, the timer 208, and the network interface 210, the disclosure may not be limiting and the electronic device 102 may include more or less components to perform the same or other functions of the electronic device 102. Details of the other functions and the components have been omitted from the disclosure for the sake of brevity. The functions or operations executed by the electronic device 102, as described in FIG. 1, may be performed by the processor 202. Operations executed by the processor 202 are described, for example, in the FIGS. 3A-3C.

FIGS. 3A-3C are diagrams that collectively illustrate a first exemplary scenario for a gesture-based application control in the electronic device of FIG. 1 in accordance with an embodiment of the disclosure. FIGS. 3A-3C are explained in conjunction with elements from FIGS. 1 and 2. With reference to FIGS. 3A-3C, there is shown an exemplary scenario 300 to illustrate a sequence of relative operations of the gesture-based application control of the electronic device 102. The sequence of relative operations may include a first gesture operation (as shown in FIG. 3A), a second gesture operation (as shown in FIG. 3B), and a display operation (as shown in FIG. 3C).

Referring to FIG. 3A, there is shown a user interface 302 for the first gesture operation on the electronic device 102 (i.e. such as a mobile phone). In an embodiment, the user interface 302 (for example a touch screen) may be a combination of the first user interface 104 and the second user interface 108. The functions of the user interface 302 may be the same as the functions of the combination of the first user interface 104 and the second user interface 108. Therefore, the further description of the user interface 302 is omitted from the disclosure for the sake of brevity. In operation, the electronic device 102 may configure the user interface 302 to be executable, for example, at a home screen or a desktop screen of the electronic device 102. In an embodiment, the user 118 or any user device (such as touch pen or stylus) may provide (i.e. draw) information about a first gesture 302A (such as a touch gesture) on the user interface 302. In other words, the user 118 (using the finger or the user device) may draw the first gesture 302A on the user interface 302, as shown for example in FIG. 3A. In an embodiment, the first gesture 302A may be formed as one of: a character (such as alphabetical or numerical letters, for example, “A”, “B”, “C”, “1”, “2”, etc.), a symbol (such as special letters, for example, $, %, etc.), or a custom shape (such as a shape, for example, a car) which may be drawn on the user interface 302. The first gesture 302A may be related to at least one application of interest (such as, but is not limited to, a vehicle maintenance application) from the plurality of applications 110. Based on the drawing of a part of the first gesture 302A by the user 118, the electronic device 102 may auto-generate (or auto-draw) a remaining part (as shown in hidden lines in FIG. 3A) of the first gesture 302A. Based on a confirmation from the user 118 regarding the auto-generated part of the first gesture 302A, the electronic device 102 may receive the first information about the first gesture 302A (which is a combination of the part of the first gesture 302A drawn by the user 118, and the rest of the part of the first gesture 302A that may be auto-generated based on the drawn part of the first gesture 302A). Alternatively, the user 118 may have an option to cancel the auto-generated part of the first gesture 302A and may manually provide the complete user input for the first gesture 302A on the user interface 302. In other words, the user 118 may completely draw the first gesture 302A (i.e. character, symbol, shape, or any pattern) on the user interface 302. In an embodiment, the user interface 302 may recognize the first gesture 302A and generate the first information. The generated first information may indicate the recognized character, symbol, shape or pattern indicated by the drawn first gesture 302A. For example, for the first gesture 302A shown in FIG. 3A, the first information may indicate a text as a ‘car’. In another example, if the user 118 draws the first gesture 302A of a character “A”, then the first information may indicate the recognized text as “A”.

Referring to FIG. 3B, there is shown the user interface 302 for the second gesture operation. In the second gesture operation, upon reception of the first information about the first gesture 302A, the electronic device 102 may search within the gesture mapping information based on the received first information. The gesture mapping information (i.e. pre-stored in the memory 204 or the server 114) may indicate the association or relationship between the plurality of gestures 106 (i.e. including information about the first gesture 302A) and the plurality of applications 110. In some embodiments, the gesture mapping information may indicate the association between the plurality of gestures 106 and the one or more functions 112 of each of the plurality of applications 110. In an example, the gesture mapping information may be a lookup table which may indicate which particular application (or related function) is mapped to which particular gesture.

The processor 202 of the electronic device 102 may search the first information about the first gesture 302A in the gesture mapping information and retrieve information about a first set of functions that may be related to a first set of applications of the plurality of applications 110. The first set of applications may be a subset of the plurality of applications 110 and the first set of functions may be one or more functions 112 of each of the first set of applications. In an embodiment, the first set of functions may be related to the first gesture 302A drawn on the user interface 302 as shown, for example, in FIG. 3A. The information (i.e. about the first set of functions) retrieved from the gesture mapping information may indicate the functions (or the applications) are related the received first gesture 302A. For example, the first gesture 302A may be drawn as a shape of the “car” (i.e. first information). Based on the shape of the first gesture 302A, the processor 202 may determine the first set of applications (i.e. installed in the electronic device 102 or on the server 114) that are related to “car”, based on the gesture mapping information. In such example, the first set of applications may include, but are not limited to, a navigation application, a vehicle maintenance application, a vehicle insurance application, or a vehicle refueling application. Based on the gesture mapping information, the processor 202 may further determine the first set of functions related to the first set of applications.

In an embodiment, based on the determined first set of functions, the processor 202 may further determine a set of user interface icons 306 (shown in FIG. 3B) that may be related to the first set of functions of the first set of applications. As shown in FIG. 3B, the processor 202 may control the user interface 302 (i.e. of the second user interface 108 as a display screen) to display the set of user interface icons 306 based on the received first information about the first gesture 302A. For example, the set of user interface icons 306 may include a first user interface icon 306A, a second user interface icon 306B, a third user interface icon 306C, and a fourth user interface icon 306D. For example, the first user interface icon 306A may correspond to a vehicle maintenance function of the vehicle maintenance application, the second user interface icon 306B may correspond to a navigation function of the vehicle navigation application, the third user interface icon 306C may correspond to a nearest fuel station function of the vehicle refueling application, and the fourth user interface icon 306D may correspond to a payment function of the vehicle insurance application. Therefore, based on the received first information about the first gesture 302A, the processor 202 may identify or search different applications configured on the electronic device 102 (or on the server 114), and display icons related to the functions matching with the received first information. In another example, if the received first information about the first gesture 302A corresponds to a dollar sign (′V), then the processor 202 may search the functions/applications related to different financial or monetary aspects (for example, but not limited to, a bill payment function/application, a stock-related function/application, a revenue-related function/application, an expense related function/application, a tax-related function/application, or a profit-lose statement function/application).

Further, based on the determined first set of functions and/or the display of the set of user interface icons 306, the electronic device 102 may display a subsidiary user interface 304 on the user interface 302 as shown, for example, in FIG. 3B. In an embodiment, the subsidiary user interface 304 may be a portion on the user interface 302. For example, the portion may be judiciously located based on the location of the set of user interface icons 306 displayed on the user interface 302. As shown in FIG. 3B, for example, the portion may be located at the center of the set of user interface icons 306 related to the determined first set of functions. The subsidiary user interface 304 may be configured to receive a second gesture 304A (such as a touch gesture) from the user 118 or via the user device (i.e. touch pen or stylus). Similar to the first gesture 302A, the second gesture 304A may related to one of: but is not limited to, a character (such as alphabetical or numerical letters), a symbol (such as special letters), a shape, or a pattern drawn inside the subsidiary user interface 304.

The user interface 302 (i.e. including the subsidiary user interface 304) may be further configured to recognize the second gesture 304A and generate the second information which may indicate recognized information for the second gesture 304A. The processor 202 of the electronic device 102 may be further configured to receive the second information (i.e. recognized information) about the second gesture 304A from the user interface 302 including the subsidiary user interface 304. In an embodiment, the second information about the second gesture 106B may be received within the predefined time (in milliseconds or seconds) from the receipt of the first information. The processor 202 may discard the second information when the second gesture 304A is not received within the predefined time. For example, the second gesture 304A drawn by the user 118 may be similar or substantially similar to the first user interface icon 306A (i.e. the vehicle maintenance function or application). In such case, the second information may indicate the drawn second gesture 304A and the processor 202 may determine at least one function (i.e. a first function) from the first set of functions based on the second information. In an embodiment, the processor 202 may compare the second information about the second gesture 304A with the gesture mapping information to retrieve (or search) information about the first function associated with the second gesture 304A. With respect to FIG. 3B, for example, the first function may correspond to the vehicle maintenance function (or related application shown in FIG. 3C) related to the second gesture 304A drawn by the user 118 on the subsidiary user interface 304. In an embodiment, the first function may be one of the first set of functions determined based on the received first gesture 302A (shown in FIG. 3A). Therefore, as described in FIGS. 3A-3B, based on the combination of the first gesture 302A and the second gesture 304A, the electronic device 102 may allow the user 118 to quickly determine and access a specific function (such as vehicle maintenance function) of a specific application (such as vehicle maintenance application) configured or installed on the electronic device 102 or on the server 114.

In another embodiment, based on the displayed set of user interface icons 306 related to the first set of functions for the first gesture 302A, the electronic device 102 may control the user interface 302 to receive the motion gesture (such as a swipe gesture, a tilt gesture, or a tap gesture as described in FIGS. 4A-4C) as the second gesture 304A (rather than receipt of the touch gesture as the second gesture 304A). The motion gesture as the second gesture 304A are further described, for example, in FIGS. 4A-4C.

With reference to FIG. 3B, there is further shown a custom user interface icon 308. The custom user interface icon 308 may allow the user 118 to add (or map) a new or existing function of one of the plurality of applications 110, with the first gesture 302A (i.e. such as “car” shape). The user interface 302 may allow the user 118 (i.e. via a click of the custom user interface icon 308) to map the new/existing function(s) with the first gesture 302A or with the second gesture 304A. Based on the added or mapped function(s), the processor 202 may update the gesture mapping information to associate newly added or mapped function/application with the first gesture 302A, such that a user interface icon (similar to the set of user interface icons 306) related to the newly mapped functions may be displayed when the first gesture 302A may be drawn by the user 118 in future. In an embodiment, the newly mapped function may be associated with one of the first set of applications determined based on the first gesture 302A or may be associated with other applications of the plurality of applications 110. In an example, the newly mapped functions(s) may be frequently accessed functions/features by the user 118 that may be related to the car/vehicle (i.e. indicated in the first gesture 302A as an example). In another example, the newly mapped functions(s) may be a newly installed function/application on the electronic device 102 (or on the server 114), that may be related to the first gesture 302A.

Referring to FIG. 3C, the display operation is provided. Based on the received second information about the second gesture 304A (such as the motion gesture or the touch gesture), the electronic device 102 may be configured to display information on a user interface of a first application 310 (for example, the vehicle maintenance application or function) that may be associated with the second gesture 304A. The displayed first application 310 may be related to the first function mapped to the second gesture 304A as described, for example, in FIG. 3B. Based on the determined first function (i.e. for example the vehicle maintenance function) based on the second gesture 304A, the processor 202 may control the execution the first application 310 related to the determined first function, and further display the information about the first application 310 on the display screen, as shown in FIG. 3C. The displayed first application 310 may include a set of user interface icons 310A that may be configured to control sub-functions of the first application 310. For example, in FIG. 3C, the first application 310 (i.e., the vehicle maintenance application or function) may include the set of user interface icons 310A, such as, but not limited to, a vehicle washing icon, a door control icon, a brake control icon, or a light control icon. Thus, using the set of user interface icons 310A, the electronic device 102 may allow the user 118 to execute or access any specific sub-functions. In another embodiment, rather than execution or initiation of the first application 310 based on the received second gesture 304A, the processor 202 may directly execute the first function (i.e. for example a vehicle washing function related to the vehicle washing icon) related to the first application 310. For example, using the vehicle washing function, the user 118 may book a vehicle washing service with a service station related to the vehicle of the user 118.

In FIG. 3C, there is further shown a user interface element 312. The electronic device 102 may also configured to display the user interface element 312 associated with the first application 310 of the plurality of applications 110. The displayed user interface element 312 may be triggered (based on touch gesture like a click) to re-initiate the first gesture operation on a portion that overlays the application. Details of such overlaid portion on the application are further described, for example, in FIGS. 5A-5D.

It may be noted that the access to the first application 310 (or related functions) as a vehicle maintenance application, based on the combination of the first gesture 302A and the second gesture 304A is described in FIGS. 3A-3C, merely as an example. The combination of different types of the first gesture 302A and the second gesture 304A may be applicable to access or control different types of the plurality of applications 110, without a deviation from the scope of the disclosure. Different examples of types of the plurality of applications 110 are provided, for example, in FIG. 1.

FIGS. 4A-4C are diagrams that collectively illustrate exemplary gestures for a gesture-based application control in the electronic device of FIG. 1 in accordance with an embodiment of the disclosure. FIGS. 4A-4C are explained in conjunction with elements from FIGS. 1, 2, and 3A-3C. There is shown an exemplary scenario 400 to illustrate various exemplary gestures (i.e. such as the second gesture 106B) for the electronic device 102. The exemplary gestures (as the second gesture 304A) may include touch-based gestures, such as, but not limited to, a swipe gesture (as shown in FIG. 4A) and a tap gesture (as shown in FIG. 4C). The exemplary gestures (as the second gesture 106B) may further include, motion gestures related to a motion associated with the electronic device 102, such as, but not limited to, a tilt gesture (as shown in FIG. 4B), or an orientation gesture.

Referring to FIG. 4A, there is shown the user interface 302 for the swipe gesture as the second gesture 106B. In an embodiment, based on the received first information about the first gesture 302A, the processor 202 may control the user interface 302 (such as the touch screen) of the electronic device 102 to display a set of user interface instructions 402 for the second gesture 106B. The set of user interface instructions 402 may include instructions for the user 118 to provide the swipe gesture (as the second gesture 106B) on the user interface 302 to select one of the set of user interface icons 306 (as shown in FIGS. 4A and 3B). Each user interface instruction of the set of user interface instructions 402 may indicate the user 118 to provide the swipe gesture on at least one of the set of user interface icons 306 displayed on the user interface 302. For example, the set of user interface instructions 402 may include, but not limited to, a first user interface instruction 402A, a second user interface instruction 402B, a third user interface instruction 402C, and a fourth user interface instruction 402D. The first user interface instruction 402A may correspond to an instruction (such as a notification to “swipe left”) for the user 118 to provide the swipe gesture towards the first user interface icon 306A of the set of user interface icons 306 and to select the vehicle maintenance function or application (i.e. as selected based on the second gesture 304A in FIG. 3B). Similarly, the second user interface instruction 402B may correspond to an instruction (such as a notification to “swipe up”) for the user 118 to provide the swipe gesture towards the second user interface icon 306B of the set of user interface icons 306 and to select the navigation function or application, and vice versa for each user interface instruction of the set of user interface instructions 402. Therefore, the second gesture 106B (as the swipe gesture) or the second information may be received on the user interface 302, based on one of the displayed set of user interface instructions 402. The disclosed electronic device 102 may further recognize the second gesture 106B, and access or control the corresponding first function or application (such as the first application 310) associated with the received second information about the second gesture 106B, as described, for example, in FIGS. 3B-3C.

Referring to FIG. 4B, there is shown the user interface 302 for the tilt gesture or the orientation gesture (as the second gesture 106B). In an embodiment, based on the received first information about the first gesture 302A, the processor 202 may further control the user interface 302 of the electronic device 102 to display a user interface instruction 404 for the second gesture 106B. The user interface instruction 404 may relate to an instruction for the user 118 to provide the tilt or orientation gesture based on the movement of the electronic device 102. For example, the user interface instruction 404 may correspond to an instruction (such as a notification to “tilt left”, “tilt right”, “tilt up”, or “tilt down”) for the user 118 to provide the tilt gesture (i.e. based on the movement of the electronic device 102) and select the corresponding function/application related to each of the set of user interface icons 306. For example, the user 118 may tilt the electronic device 102 in a left direction towards the first user interface icon 306A (shown in FIGS. 3B and 4B) of the set of user interface icons 306 to select the vehicle maintenance function or application (i.e. as selected based on the second gesture 304A in FIG. 3B). In another example, the user 118 may tilt the electronic device 102 in the right direction towards the third user interface icon 306C (shown in FIG. 3B) to select the nearest fuel station function or application (i.e. as selected based on the second gesture 304A in FIG. 3B). In some embodiments, the electronic device 102 may allow the user 118 to easily toggle between different functions (for example between the vehicle maintenance function and the nearest fuel station function) based on the real-time change in the tilt angle of the electronic device 102.

In an embodiment, the tilt gesture may also be an orientation gesture (such as a portrait orientation or a landscape orientation) associated with the electronic device 102. One skilled in the art may understand that the user interface instruction 404 (i.e. a notification for the user 118) to tilt or orient the electronic device 102 for the selection of corresponding user interface icon (or function/application) is shown merely as an example. The electronic device 102 may provide different types of notifications (such text-based or audio-based) to the user 118 to provide the motion gesture (i.e. tilt or orientation) to select the corresponding function based on the second gesture 106B, as the motion gesture. In an embodiment, the electronic device 102 may further recognize the received second gesture 106B, and further access or control the corresponding first function or application (such as the first application 310) associated with the received second information, as described, for example, in FIGS. 3B-3C.

In an embodiment, the motion gesture may relate to a shake gesture (i.e. shaking the electronic device 102) as the second gesture 106B. In such case, the processor 202 may discard the received first information about the first gesture 106A, based on a determination that the second gesture 106B is the shake gesture as the motion gesture. For example, if the user 118 inadvertently provided the first gesture 106A, which is not of interest, the user 118 may perform the shake gesture (as the second gesture 106B) on the electronic device 102 to discard the received first information about the first gesture 106A and may further remove the set of user interface icons 306 displayed corresponding to the first gesture 106A. In such case, the electronic device 102 may provide a user interface (such as home screen or desktop screen) to receive the first gesture 106A (i.e. first gesture 302A shown in FIG. 3A).

Referring to FIG. 4C, there is shown the user interface 302 for the tap gesture (as the second gesture 106B). In an embodiment, based on the received first information about the first gesture 302A, the processor 202 may further control the user interface 302 of the electronic device 102 to display a user interface instruction 406 for the second gesture 106B. The user interface instruction 406 may relate to an instruction for the user 118 to provide the tap gesture (i.e. as the second gesture 106B) on the user interface 302. For example, the user interface instruction 406 may correspond to an instruction (such as a notification to “tap on the second user interface icon 306B”) for the user 118 to provide the tap gesture on the second user interface icon 306B of the set of user interface icons 306, and select the corresponding function/application related to the second user interface icon 306B. For example, the user 118 may provide the tap gesture (i.e. as the second gesture 106B) on the second user interface icon 306B (as shown in FIGS. 3B and 4C) of the set of user interface icons 306 to select the navigation function or application (i.e. as selected based on the second gesture 304A in FIG. 3B). The navigation function or application may correspond to a live tracking application as shown in FIG. 5D. In another example, the user 118 may provide tap gesture (i.e. as the second gesture 106B) on the first user interface icon 306A (shown in FIGS. 3B and 4B) of the set of user interface icons 306 to select the vehicle maintenance function or application (i.e. as selected based on the second gesture 304A in FIGS. 3B and 3C).

In an embodiment, the user interface instruction 406 may provide a notification for the user 118 to tap on one of the set of user interface icons 306 of the electronic device 102 for the selection of a corresponding user interface icon (or function/application). For example, the notification may include an icon (such as a pointing finger icon as shown in FIG. 4C) to notify the user 118 about the tap gesture on one of the set of user interface icons 306. It may be noted that the notification shown in FIG. 4C is presented merely as an example. The present disclosure may be also applicable to other types of the notifications such as a text-based notification, an audio-based notification, or a vibratory notification. Description of other types of the notifications has been omitted from the disclosure for the sake of brevity. The electronic device 102 may provide such different types of notifications, such that the user 118 may provide the tap gesture on one of the set of user interface icons 306 displayed on the user interface 302, to further select the corresponding function based on the tap gesture (i.e. the second gesture 106B). In an embodiment, the electronic device 102 may further recognize the received second gesture 106B, and further access or control the corresponding first function or application (such as the first application 310) associated with the received second information, as described, for example, in FIGS. 3B-3C.

FIGS. 5A-5D are diagrams that collectively illustrate a second exemplary scenario for a gesture-based application control in the electronic device of FIG. 1, in accordance with an embodiment of the disclosure. FIGS. 5A-5D are explained in conjunction with elements from FIGS. 1, 2, 3A-3C, and 4A-4C. With reference to FIGS. 5A-5D, there is shown an exemplary scenario 500 to illustrate a sequence of relative operations of the gesture-based application control of the electronic device 102. The sequence of relative operations may include a combined gesture operation (as shown in FIG. 5A), a first application display operation (as shown in FIG. 5B), an overlay operation (as shown in FIG. 5C), and a second application display operation (as shown in FIG. 5D).

Referring to FIG. 5A, there is shown a user interface 302 for the combined gesture operation. In an embodiment, the electronic device 102 may allow the user 118 to provide a combined gesture 502 (such as a combination of at least two characters, symbols, or custom shapes) to the user interface 302. For example, the combined gesture 502 shown in FIG. 5A, may be a representation of a custom shape (such as a vehicle) and a character (such as letter ‘M’), which may denote a specific function (such as a vehicle maintenance function). In an embodiment, the combined gesture 502 may be the combination of the first gesture 106A (i.e. shape of car) and the second gesture 106B (i.e. a character CM′ drawn within the predefined time) both provided at the home screen or the desktop screen of the electronic device 102, as shown in FIG. 5A. Based on the combined gesture 502, the electronic device 102 may directly execute or display the first application 310 (shown in FIG. 5B) related to the combined gesture 502, without any requirement for separately drawn second gesture 304A as described in FIGS. 3B and 4A-4C.

Referring to FIG. 5B, there is shown the first application display operation. Based on the received first information and the second information about the combined gesture 502, the electronic device 102 may display information associated with the first application 310 (or related function) mapped with the combined gesture 502. The mapping between the first application 310 (i.e. vehicle maintenance function or application) and the combined gesture 502 may be indicated in the gesture mapping information. As described, for example, in FIG. 3C, the electronic device 102 may also be configured to display the user interface element 312 associated with the first application 310 of the plurality of applications 110.

Referring to FIG. 5C, there is shown the overlay operation. In an embodiment, the displayed user interface element 312 (in FIG. 5B) may be triggered (or clicked) to initiate a new gesture operation (such as the first gesture operation as described in FIG. 3A, or the combined gesture operation as described in FIG. 5A) on a portion 504 (such as a pop-up window) that overlays the first application 310 (such as the vehicle maintenance application). In the new gesture operation, the electronic device 102 may allow the user 118 to provide a new gesture 504A (such as the first gesture 302A or the combined gesture 502) on the portion 504 that may be overlaid on the displayed first application 310. In an embodiment, the electronic device 102 may receive the first gesture (such as the new gesture 504A) based on the trigger of the user interface element 312 associated with at the first application 310 of the plurality of applications 110 of the electronic device 102. The electronic device 102 may further configured to receive the second gesture (as shown in FIG. 7C) from the portion 504 that overlays the first application 310 based on the trigger of the user interface element.

Referring to FIG. 5D, there is shown the second application display operation. In an embodiment, the electronic device 102 may receive information about the new gesture 504A (such as a geo-location gesture). Based on the received information, the processor 202 of the electronic device 102 may refer to the prestored gesture mapping information to identify a second application 506 (or a function) that may be pre-mapped with the new gesture 504A. The processor 202 may further control the display screen to display information associated with the second application 506 (such as the live tracking application shown in FIG. 5D). The electronic device 102 may also be configured to display the user interface element 312 associated with the second application 506 of the plurality of applications 110. In an embodiment, the second application 506 (such as the live tracking application) may be different from the first application 310 (such as the vehicle maintenance application) from which the new gesture 504A may be triggered or drawn. Thus, the disclosed electronic device 102 may allow the user 118 to search or identify the second application 506 (or related functions) while the gesture is provided during an execution phase of different application (i.e. first application 310). This may allow the user 118 to globally search (or access/execute) any function or application installed on the electronic device 102 (or on the server 114), while operating different applications/function as described, for example, in FIGS. 5B-5D, rather than executing or accessing the second application from the home screen or from a pre-defined area designated to provide initial gestures. Thus, electronic device 102 may allow the user 118 to search different functions/applications outside an application, which the user 118 may be currently executing or exploring. This further facilitate the user 118 to easily switch between different applications in time-efficient manner.

FIGS. 6A-6C are diagrams that collectively illustrate a third exemplary scenario for a gesture-based application control in the electronic device of FIG. 1, in accordance with an embodiment of the disclosure. FIGS. 6A-6C are explained in conjunction with elements from FIGS. 1, 2, 3A-3C, 4A-4C, and 5A-5D. With reference to FIGS. 6A-6C, there is shown an exemplary scenario 600 to illustrate a sequence of relative operations of the gesture-based application control of the electronic device 102. The sequence of relative operations may include a first gesture operation (as shown in FIG. 6A), an in-line second gesture operation (as shown in FIG. 6B), and an application display operation (as shown in FIG. 6C).

Referring to FIG. 6A, there is shown the first gesture operation. In the first gesture operation, the electronic device 102 may allow the user 118 to provide the first gesture 302A, for example from the home screen (i.e. similar to described in FIG. 3A). In an embodiment, the electronic device may be configured to receive the first information about the first gesture 302A (or about the combined gesture 502), as shown in FIG. 3A and FIG. 5A. Based on the received first information, the electronic device 102 may determine the application or function mapped to the first gesture 302A based on the prestored gesture mapping information. For example, based on the received first gesture 302A (as a car symbol), the electronic device 102 may determine and execute the first application 310 (i.e. vehicle maintenance function/application shown in FIG. 6B), considering that only one application/function may be associated with the first gesture 302A drawn in FIG. 6A (in contrast to multiple applications and related icons shown, for example, in FIG. 3B).

Referring to FIG. 6B, there is shown the in-line second gesture operation. In an embodiment, the electronic device 102 may allow the user 118 to provide the user inputs on a portion 602 of the executed/displayed first application 310. The portion 602 may be in-line, such as a part of the first application 310 and within the displayed information of the first application 310 as shown in FIG. 6B. The electronic device 102 may be configured to receive gesture-based user inputs (such as the first gesture 106A, the second gesture 106B, or the combined gesture 502) directly on the first application 310 without any pop-up window (such as the portion 504 shown in FIG. 5C). As shown in FIG. 6B, for example, the gesture-based user inputs may be a gesture 602A (for example a geo-location symbol drawn by the user 118. Such reception of the gesture-based user inputs directly on the first application 310 may avoid distractions that may have caused due to the pop-up window to the user 118, and may further improve user experience to provide any touch-based gesture to access or execute any corresponding function/application in time-efficient manner.

Referring to FIG. 6C, there is shown the application display operation. In an embodiment, based on the gesture-based inputs (i.e. such as geo-location symbol) that may be received directly on the first application 310, as shown in FIG. 6B, the electronic device 102 may be configured to search the gesture mapping information and determine the second application 506 (such as the live tracking application) associated with the gesture-based inputs (i.e. such as geo-location symbol) provided on the portion 602 of the first application 310. In some embodiments, based on the gesture mapping information, the electronic device 102 may directly execute one or more functions 112 (i.e. of the first function) of the second application 506, based on the gesture-based inputs (i.e. such as geo-location symbol) provided on the portion 602 of the first application 310. The portion 602 may be related to the executed first function of the first set of functions. For example, the first function of the second application 506 may be “a current location function” mapped to the geo-location symbol (i.e. gesture-based inputs) drawn directly on the first application 310. The second application 506 may be different from the first application 310 (such as the vehicle maintenance application from which the gesture-based inputs is provided directly, as shown in FIG. 6B). In an alternate embodiment, the gesture-based inputs that may be provided on the first application 310, may be associated with one or more functions 112 of the first application 310, rather than the second application 506.

FIGS. 7A-7D are diagrams that collectively illustrate a fourth exemplary scenario for a gesture-based application control in the electronic device of FIG. 1, in accordance with an embodiment of the disclosure. FIGS. 7A-7D are explained in conjunction with elements from FIGS. 1, 2, 3A-3C, 4A-4C, 5A-5D, and 6A-6C. With reference to FIGS. 7A-7D, there is shown an exemplary scenario 700 to illustrate a sequence of relative operations of the gesture-based application control of the electronic device 102. The sequence of relative operations may include a gesture access operation (as shown in FIG. 7A), a first navigation gesture operation (as shown in FIG. 7B), a second navigation gesture operation (as shown in FIG. 7C), and a sub-function operation (as shown in FIG. 7D). Referring to FIG. 7A, there is shown gesture access operation. In operation, the electronic device 102 may control the user interface 302 to directly display the first application 310. In order to provide the gesture-based user inputs from the first application 310, the electronic device 102 may allow the user 118 to trigger (or click) the user interface element 312, as shown in FIG. 7A and in FIG. 5B.

Referring to FIG. 7B, there is shown the first navigation gesture operation. In operation, based on the trigger (or click) from the user interface element 312, the electronic device 102 may control the user interface 302 (in FIG. 7A) to display the portion 504 on the first application 310. The electronic device 102 may further allow the user 118 to provide a navigation gesture 702 on the portion 504. In an example, the navigation gesture 702 (i.e. similar to the first gesture 106A) may be a touch gesture that may form a closed circuit. In another embodiment, the navigation gesture 702 may be a touch gesture that may form an open circuit (as shown by a dotted semicircle in FIG. 7B). In another embodiment, the navigation gesture 702 may be provided as one of: a character, a symbol, or a custom shape. Based on the received navigation gesture 702 on the portion 504 of the user interface 302, the electronic device 102 may be configured to recognize the navigation gesture 702 (as the first gesture 106A or the first gesture 302A described in FIG. 3A) and receive the first information associated with the navigation gesture 702.

Referring to FIG. 7C, there is shown the second navigation gesture operation. In operation, based on the received first information associated with the navigation gesture 702, the electronic device 102 may further configure the user interface 302 to display a set of user interface icons 704. The set of user interface icons 704 may include, but not limited to, a first user interface icon 704A, a second user interface icon 704B, a third user interface icon 704C, and a fourth user interface icon 704D. The set of user interface icons 704 may be related to the first set of functions or applications that may be mapped to the navigation gesture 702 (as described, for example, in FIGS. 3A-3B). The functions of the set of user interface icons 704 may be same as the functions of the set of user interface icons 306 (i.e. described in FIG. 3B). Therefore, the further description of the set of user interface icons 704 is omitted from the disclosure for the sake of brevity.

Further, based on the display of the set of user interface icons 704, the electronic device 102 may further configure the user interface 302 to display a set of user interface instructions 706 for the set of user interface icons 704. In an embodiment, the electronic device 102 may allow the user 118 to provide a second navigation gesture (such as at least one of: a touch gesture, a swipe gesture, a tilt gesture, a tap gesture), based on the displayed set of user interface instructions 706, as described in FIGS. 4A-4C. For example, based on the displayed set of user interface instructions 706, the electronic device 102 may allow the user 118 to provide the second navigation gesture to select the first user interface icon 704A of the set of user interface icons 704. Based on the second navigation gesture for the selected first user interface icon 704A, the electronic device 102 may receive the second information about the second navigation gesture.

Referring to FIG. 7D, there is shown the sub-function operation. Based on the received second information about the second navigation gesture, the electronic device 102 may be configured to display information of a sub-function 708 (such as a vehicle servicing booking function) that may be associated with the selected first user interface icon 704A. In an embodiment, the first user interface (such as the user interface 302 displaying the first application 310 in FIG. 7A) and the first set of functions (i.e. related to the set of user interface icons 704 which are identified based on the first gesture 106A provided on the user interface 302) may be related to the first application 310 of the plurality of applications 110. In an alternate embodiment, the first user interface (such as the user interface 302 displaying the first application 310 in FIG. 7A) may be related with the first application 310, however at least one of the first set of functions (i.e. determined based on the first gesture 106A) may be related to a new/another application (such as the second application 506 shown in FIG. 6C) different from the first application 310.

FIGS. 8A-8D are diagrams that collectively illustrate a fifth exemplary scenario for a gesture-based application control in the electronic device of FIG. 1, in accordance with an embodiment of the disclosure. FIGS. 8A-8D are explained in conjunction with elements from FIGS. 1, 2, 3A-3C, 4A-4C, 5A-5D, 6A-6C, and 7A-7D. With reference to FIGS. 8A-8D, there is shown an exemplary scenario 800 to illustrate a sequence of relative operations of the gesture-based application control of the electronic device 102. The sequence of relative operations may include a gesture access operation (as shown in FIG. 8A), a first gesture operation (as shown in FIG. 8B), a second gesture operation (as shown in FIG. 8C), and a sub-function operation (as shown in FIG. 8D). Referring to FIG. 8A, there is shown the gesture access operation. In operation, the electronic device 102 may control the user interface 302 to directly display the first application 310. In order to access the gesture-based user inputs from the first application 310, the electronic device 102 may allow the user 118 to trigger the user interface element 312, as shown in FIGS. 8A, 7A and 5B.

Referring to FIG. 8B, there is shown the first gesture operation. In operation, based on the trigger (or click) from the user interface element 312, the electronic device 102 may control the user interface 302 (in FIG. 8A) to display the portion 504 on the first application 310 (as shown in FIG. 8B). The electronic device 102 may further allow the user 118 to provide a new gesture 802 on the portion 504. In an example, the new gesture 802 may be a touch gesture. In an embodiment, the new gesture 802 may also be formed as the combined gesture 502. For example, the new gesture 802 may also be provided as a combination of characters, symbols, or custom shapes. In an embodiment, the new gesture 802 may be provided completely or as a part, such that the electronic device 102 may auto-generate the complete gesture based on the provided or drawn part. In some embodiments, the new gesture 802 may be similar to the first gesture 106A or the first gesture 302A. Based on the received new gesture 802 on the portion 504 of the user interface 302, the electronic device 102 may be configured to recognize the new gesture 802 and receive the first information associated with the new gesture 802. In an example, the new gesture 802 shown in FIG. 8B may be a gesture associated with a social networking communication application or function.

Referring to FIG. 8C, there is shown the second gesture operation. In operation, based on the received first information associated with the new gesture 802, the electronic device 102 may further configure the user interface 302 to display a set of user interface icons 804. The set of user interface icons 804 may include, but not limited to, a first user interface icon 804A, a second user interface icon 804B, a third user interface icon 804C, and a fourth user interface icon 804D. The set of user interface icons 804 may be related to the first set of functions or applications that may be mapped to the new gesture 802 (as described, for example, in FIGS. 3A-3B). The functions of the set of user interface icons 804 may be same as the functions of the set of user interface icons 306 (i.e. described in FIG. 3B). Therefore, the further description of the set of user interface icons 804 is omitted from the disclosure for the sake of brevity.

Further, based on the display of the set of user interface icons 804, the electronic device 102 may further configure the user interface 302 to display a set of user interface instructions 806 for the set of user interface icons 804. In an embodiment, the electronic device 102 may allow the user 118 to provide a sub-function gesture (such as at least one of: a touch gesture, a swipe gesture, a tilt gesture, a tap gesture, or any other type of second gesture), based on the displayed set of user interface instructions 806, as described in FIGS. 4A-4C. For example, based on the displayed set of user interface instructions 806, the electronic device 102 may allow the user 118 to provide the sub-function gesture to select the first user interface icon 804A of the set of user interface icons 804. Based on sub-function gesture for the selected first user interface icon 804A, the electronic device 102 may receive second information about the sub-function gesture.

Referring to FIG. 8D, there is shown the sub-function operation. Based on the received second information about the sub-function gesture, the electronic device 102 may be configured to display information of a sub-function 808. In an example, the sub-function 808 may be a chat function of a new application 810 (such as a social networking application) that may be associated with the selected first user interface icon 804A. In an embodiment, the user interface 302 (shown at FIG. 8A) may be associated with the first application 310 and the first set of functions (including the sub-function 808) associated with the new gesture 802 (such as the first gesture 106A), may be related to a new application 810 (such as the second application 110B) of the first set of applications of the plurality of applications 110. In an embodiment, the first application 310 may be different from the new application 810 (i.e., the second application).

In some embodiments, one or more of the first set of functions associated with the new gesture 802 (such as the first gesture 106A in FIG. 8B) may be related to the first application 310, however the sub-function 808 (i.e. the first function as “chat function” selected based on the sub-function gesture in FIG. 8C) may be related to the new application 810 (i.e., the second application). For example, a second function of the first set of functions associated with one of the set of user interface icons 804 is related to the first application 310 (for example, the fourth user interface icon 804D may be related to the second function to send a message to vehicle maintenance operator is related to the first application 310). However, the sub-function (i.e. first function) selected based on the sub-function gesture is related to the new application 810 (i.e., the second application), different from the first application 310.

It may be noted that different sequence of operations shown in FIGS. 3A-3C, 4A-4C, 5A-5D, 6A-6C, 7A-7D, and 8A-8D to access, control, or execute different applications (either from home screen or another application) in time-efficient manner, based on the combination of gesture-based inputs (i.e. the first gesture 106A and/or the second gesture 106B), are presented merely as examples. There may be several different types or patterns of gesture-based inputs can be provided in various sequences to access, control, or execute various types of applications/function in time efficient manner, without a deviation from the scope of disclosure.

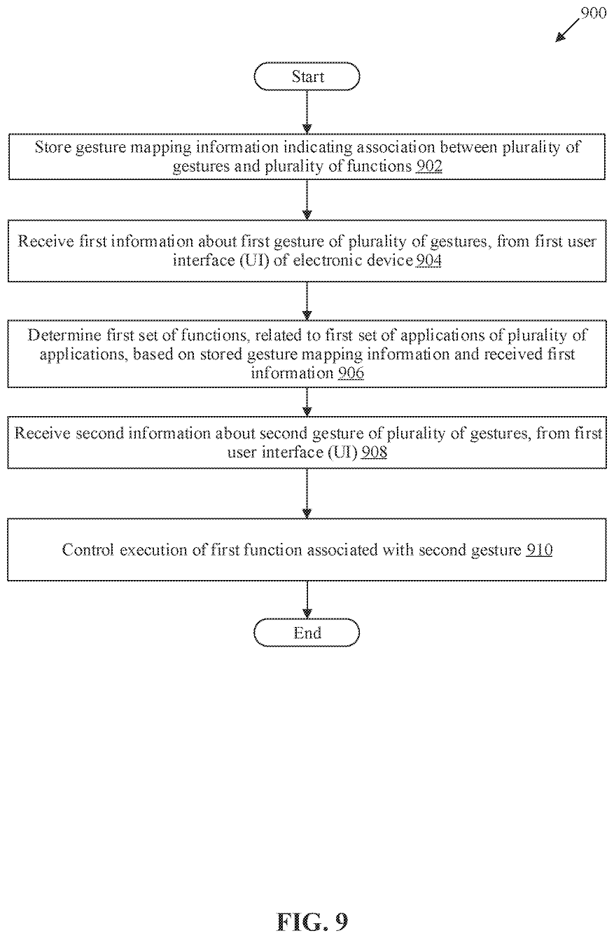

FIG. 9 is a flowchart that illustrates exemplary operations for a gesture-based application control in the electronic device of FIG. 1, in accordance with an embodiment of the disclosure. FIG. 9 is explained in conjunction with elements from FIGS. 1, 2, 3A-3C, 4A-4C, 5A-5D, 6A-6C, 7A-7D, and 8A-8D. With reference to FIG. 9, there is shown a flowchart 900 that depicts a method for gesture-based application control of the electronic device 102 of FIG. 1. The method may be executed by the electronic device 102 of FIG. 1 or by the processor 202 of FIG. 2. The method illustrated in the flowchart 900 may start from 902.

At 902, the gesture mapping information that may indicate the association between the plurality of gestures 106 and plurality of functions may be stored. In an embodiment, the processor 202 may control the memory 204 to store the gesture mapping information that may indicate the association between plurality of gestures 106 and plurality of functions, as described for example, in FIGS. 1, 2, and 3A.

At 904, the first information about the first gesture 106A of the plurality of gestures 106 may be received, from the first user interface 104 of the electronic device 102. In an embodiment, the electronic device 102 or the processor 202 may receive the first information about the first gesture 106A of the plurality of gestures 106, from the first user interface 104 of the electronic device 102, as described, for example, in FIGS. 1, 3A, 5A, and 6A.

At 906, the first set of functions (such as the one or more functions 112), related to the first set of applications (such as the first application 110A and the second application 110B) of the plurality of applications 110 may be determined, based on the stored gesture mapping information and the received first information. In an embodiment, the electronic device 102 or the processor 202 may determine the first set of functions (such as the one or more functions 112), related to the first set of applications (such as the first application 110A and the second application 110B) of the plurality of applications 110, as described in FIGS. 1 and 3A.

At 908, the second information about the second gesture 106B of the plurality of gestures 106 may be received, from the first user interface 104. In an embodiment, the electronic device 102 or the processor 202 may receive the second information about the second gesture 106B of the plurality of gestures 106, from the first user interface 104, as described in FIGS. 1 and 3B.

At 910, the execution of the first function associated with the second gesture 106B may be controlled. In an embodiment, the electronic device 102 may control the execution of the first function associated with the second gesture 1066, as described in FIGS. 1 and 3C. Control may pass to end.

The flowchart 900 is illustrated as discrete operations, such as 902, 904, 906, 908, and 910. However, in certain embodiments, such discrete operations may be further divided into additional operations, combined into fewer operations, or eliminated, or rearranged, depending on the implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (for example the electronic device 102) for the gesture-based application control. The set of instructions may be executable by the machine and/or the computer (for example the electronic device 102) to perform operations that may include reception of the first information about a first gesture (such as the first gesture 106A) of the plurality of gestures 106, from a first user interface (such as the first user interface 104) of the electronic device 102. The operations may further include determination of the first set of functions, related to the first set of applications (such as the first application 110A and the second application 1106) of the plurality of applications 110, based on stored gesture mapping information and the received first information (such as from the first user interface 104). The gesture mapping information may indicate an association between the plurality of gestures 106 and a plurality of functions associated with a plurality of applications 110 configured in the electronic device 102. The operations may further include reception of the second information about the second gesture 106B of the plurality of gestures 106, from the first user interface 104. The operations may further include the control of the execution of a first function associated with the second gesture 106B of the plurality of gestures 106.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a situation or material to the teachings of the present disclosure without departing from its scope. Therefore, it is intended that the present disclosure is not limited to the embodiment disclosed, but that the present disclosure will include all embodiments that fall within the scope of the appended claims.

What is claimed is:

1. An electronic device, comprising:
a memory which stores gesture mapping information indicating an association between a plurality of gestures and a plurality of functions, wherein the plurality of functions is associated with a plurality of applications configured in the electronic device; and
processor communicably coupled with the memory, wherein the processor:
receives first information about a first gesture of the plurality of gestures, from a first user interface of the electronic device;
determines a first set of functions, related to a first set of applications of the plurality of applications, based on the stored gesture mapping information and the received first information, wherein the first set of functions are associated with the first gesture;
receives second information about a second gesture of the plurality of gestures, from the first user interface, wherein the second information about the second gesture is received within a predefined time from the receipt of the first information and is associated with a first function of the first set of functions; and
controls an execution of the first function associated with the second gesture.

2. The electronic device according to claim 1, wherein the first gesture and the second gesture, received from the first user interface, are related to at least one of: a character, a symbol, or a custom shape.

3. The electronic device according to claim 1, wherein the first gesture is a touch gesture and the second gesture is one of: a touch gesture or a motion gesture related to a motion associated with the electronic device.

4. The electronic device according to claim 3, wherein the motion gesture is one of: a tilt gesture or an orientation gesture associated with the electronic device.

5. The electronic device according to claim 3, wherein the processor discards the received first information based on a determination that the second gesture is a shake gesture as the motion gesture.

6. The electronic device according to claim 1, wherein at least one second function of the first set of functions associated with the first gesture, is related to a first application of the first set of applications, and
wherein the first function associated with the second gesture is related to a second application of the first set of applications.

7. The electronic device according to claim 1, wherein the first user interface is associated with a first application of the plurality of applications,
wherein the first set of functions, associated with the first gesture, are related to a second application of the first set of applications of the plurality of applications, and
wherein the first application is different from the second application.

8. The electronic device according to claim 1, wherein the first user interface and the first set of functions are related to a first application of the plurality of applications.

9. The electronic device according to claim 1, wherein the processor retrieves information about the first set of functions associated with the first gesture and retrieves information about the first function associated with the second gesture, from the gesture mapping information stored in the memory.

10. The electronic device according to claim 1, wherein based on the determined first set of functions, the processor further controls a display screen of the electronic device to display a set of user interface icons related to the first set of functions.

11. The electronic device according to claim 1, wherein the second gesture is received from a portion of the first user interface and wherein the portion is related to the executed first function of the determined first set of functions.

12. The electronic device according to claim 1, wherein the first gesture or the second gesture is received based on a trigger of a user interface element associated with the first user interface, and wherein the first gesture or the second gesture is received from a portion that overlays the first user interface based on the trigger of the user interface element.

13. The electronic device according to claim 1, wherein, based on the received first information about the first gesture, the processor further:
controls a display screen of the electronic device to display a set of user interface instructions for the second gesture; and
receives the second information about the second gesture based on one of the displayed set of user interface instructions.

14. A method, comprising:
in an electronic device:
storing gesture mapping information indicating an association between a plurality of gestures and a plurality of functions, wherein the plurality of functions is associated with a plurality of applications configured in the electronic device;
receiving first information about a first gesture of the plurality of gestures, from a first user interface of the electronic device;
determining a first set of functions, related to a first set of applications of the plurality of applications, based on the stored gesture mapping information and the received first information, wherein the first set of functions are associated with the first gesture;
receiving second information about a second gesture of the plurality of gestures, from the first user interface, wherein the second information about the second gesture is received within a predefined time from the receipt of the first information and is associated with a first function of the first set of functions; and
controlling an execution of the first function associated with the second gesture.

15. The method according to claim 14, further comprising, based on the received first gesture:
controlling a display screen of the electronic device to display a set of user interface instructions for the second gesture; and
receiving the second information about the second gesture based on one of the displayed set of user interface instructions.

16. The method according to claim 14, further comprising:
retrieving information about the first set of functions associated with the first gesture and information about the first function associated with the second gesture, from the stored gesture mapping information.

17. The method according to claim 14, further comprising,
controlling a display screen of the electronic device to display a set of user interface icons related to the first set of functions, based on the determined first set of functions.

18. The method according to claim 14, wherein the first user interface is associated with a first application of the plurality of applications,
wherein the first set of functions, associated with the first gesture, are related to a second application of the first set of applications, and
wherein the first application is different from the second application.

19. The method according to claim 14, further comprising:
receiving the second gesture from a portion of the first user interface, wherein the portion is related to the executed first function of the first set of functions.

20. A non-transitory computer-readable medium having stored thereon, computer-executable instructions which, when executed by an electronic device, cause the electronic device to execute operations, the operations comprising:
storing gesture mapping information indicating an association between a plurality of gestures and a plurality of functions, wherein the plurality of functions is associated with a plurality of applications configured in the electronic device;
receiving first information about a first gesture of the plurality of gestures, from a first user interface of the electronic device;
determining a first set of functions, related to a first set of applications of the plurality of applications, based on the stored gesture mapping information and the received first information, wherein the first set of functions are associated with the first gesture;
receiving second information about a second gesture of the plurality of gestures, from the first user interface, wherein the second information about the second gesture is received within a predefined time from the receipt of the first information and is associated with a first function of the first set of functions; and
controlling an execution of the first function associated with the second gesture.
